(19) United States
(12) Patent Application Publication
(10) Pub. No.: US 2004/0024334 A1
(43) Pub. Date: Feb. 5, 2004

(54) Ultrasound endomassage device

(76) Inventor: Joan Francesc Casas Boncompte, Terrassa (ES)

Correspondence Address: YOUNG & THOMPSON, 745 SOUTH 23RD STREET 2ND FLOOR, ARLINGTON, VA, 22202

(21) Appl. No.: 10/304,758

(22) Filed: Nov. 27, 2002

(30) Foreign Application Priority Data
Jul. 31, 2002 (EP) 02380173.1

(51) Int. Cl. A61H 1/00

(52) U.S. Cl. 601/2

(57) ABSTRACT

“ULTRASOUND ENDOMASSAGE DEVICE” used in massage, slimming and anti-cellulitis treatments, comprised of a casing (1) which houses in its interior a transducer (2) of ultrasound on whose body are a series of passing holes (7) through which suction, produced by a vacuum pump, is exerted, and whose outer face may be concave, flat or convex; a vibrator (3); and, optionally, rollers (9). The casing has a handle (4) on which indicators (5) and an operating switch (6) can be found. In the case of the transducer (2) which also applies galvanic currents, the device is provided with a bracelet, plate or similar component (8) which is placed in direct contact with the patient's skin as a sort of anode.

### DESCRIPTION OF THE INVENTION

The objective of this invention, as expressed in the statement to this descriptive report, consists of an “ULTRASOUND ENDOMASSAGE DEVICE”, of the type used in slimming, anti-cellulitis and skin regeneration therapies.

These therapies are normally based on the performance of a series of different treatments of which the most common are suction or vacuum treatment, ultrasound treatment, vibratory massage and current application. The purpose of all of these treatments is to improve blood circulation, oxygenate in depth, drain fluids, clear tissue congestion and reaffirm the tissues.

Traditionally, these treatments are applied alternately: when one ends, another is started, until the cycle is completed. However, it has been shown that their synergetic use, in addition to providing a notable time-saving, increases their effect significantly. Therefore, devices have been developed that are capable of applying more than one treatment at a time, specifically, of effecting a suction and ultrasound treatment.

The innovative ultrasound endomassage device represents an important breakthrough in the field of synergetic slimming and anti-cellulitis therapies as it is able to perform up to four different treatments at the same time: vacuum, ultrasound, vibratory massage and current application.

To achieve this, the new device is made up of an ultrasound generator or transducer, joined to a vibrator, all of which is housed in a portable casing with a handle on which there are indicators and an on-off button.

The body of the transducer has a series of passing holes through which the suction is carried out, creating a vacuum when the skin comes into contact with these holes. The suction is effected by means of a vacuum pump. This pump may be attached to the exterior of the device or housed inside the casing.

The outer face of the transducer, which comes into contact with the skin, may be concave, flat or convex, and is used as a cathode for the emission of galvanic or ionising currents. Therefore, it is essential to have a bracelet, plate or similar component which has direct contact with the patient's skin and closes the circuit.

Optionally, freely rotating or motorised rollers may be situated on each side of the transducer, whose function is to massage and stimulate the patient's skin.

Through the indicators on the handle, the operator can see what treatment is being applied to the patient at any time.

The galvanic current generator, ultrasound generator and vacuum pump may be arranged in a separate casing joined to the casing with the handle by means of a hose provided with a suction tube and a number of electrical cables, for controlling the transducer, vibrating motor and other electrical parts, or they may be arranged inside the casing with the handle.

The use of this device in massage treatment will improve vascular flow, oxygenation, blood circulation, fluid drainage and tissue decongestion, acting as a skin reaffirming agent and regenerator, and reduce cellulitis and volume. It will also reduce treatment times compared to existing treatments.

### DESCRIPTION OF THE DIAGRAMS

To illustrate everything explained so far, 5 pages of drawings are attached to this descriptive report, forming an integral part of it, representing the invention in a simplified and schematic way. The drawings are intended to be purely illustrative and are not an exhaustive representation of the practical possibilities of the invention.

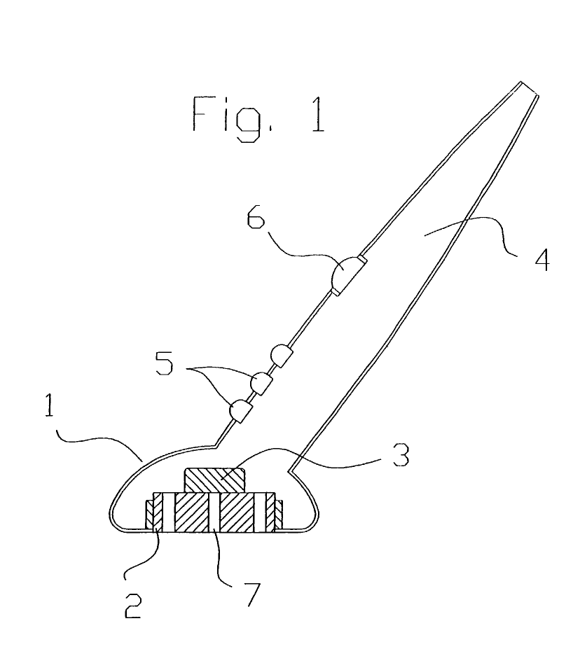

In these diagrams, FIG. 1 represents a sectional view of the length of the device of the invention.

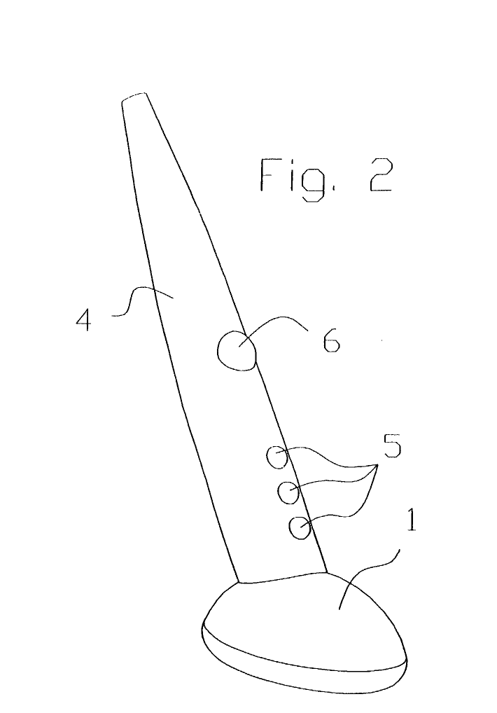

FIG. 2 represents a perspective view of the device showing the indicators and switch.

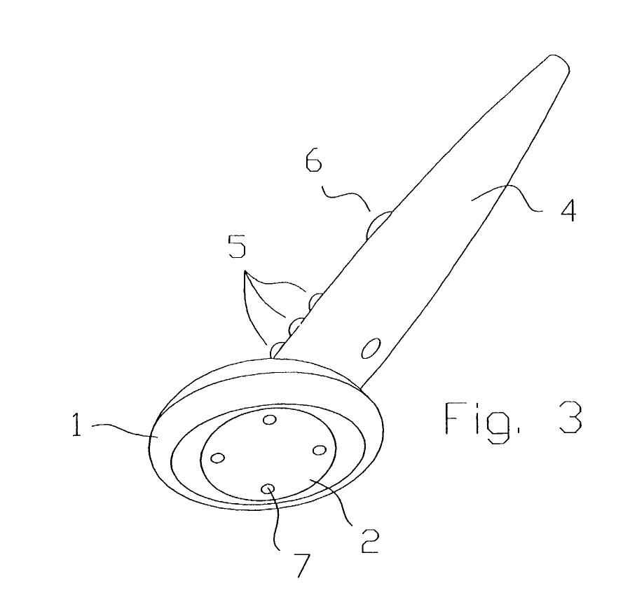

FIG. 3 represents a perspective view of the device showing the passing holes of the transducer.

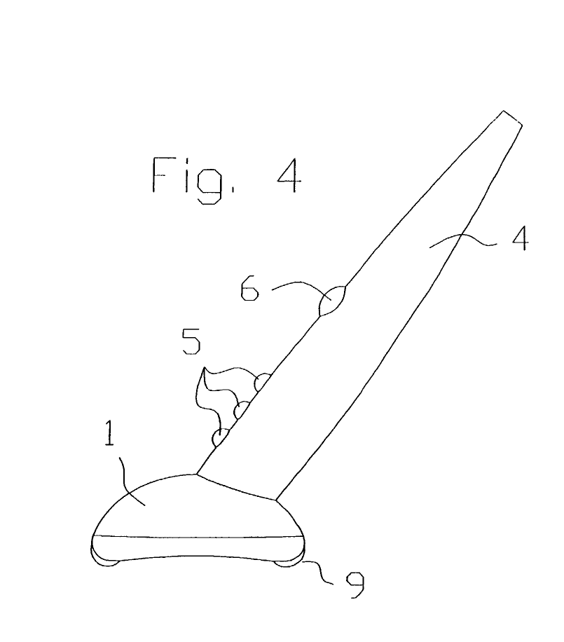

FIG. 4 represents a view of the length of the device of the invention with rollers.

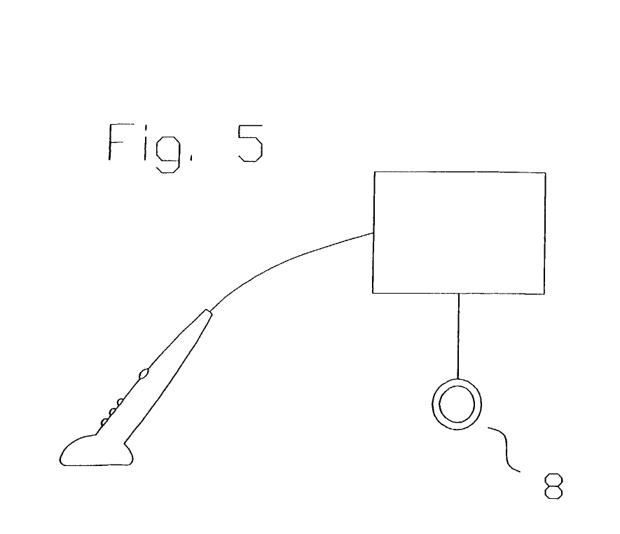

FIG. 5 is an outline of the different parts of the device showing the element that is placed in contact with the skin as a sort of anode.

### DESCRIPTION OF A PRACTICAL EXAMPLE

The device of this invention is made up of a casing (1) which houses in its interior a transducer (2) and a vibrator (3). This casing has a handle (4) on which there are some indicators (5) and an operating switch (6).

On the body of the transducer (2) are a series of passing holes (7) through which the suction of a vacuum pump (not illustrated) is effected.

The outer face of the transducer, which comes into contact with the skin, may be concave, flat or convex, and is used as a cathode to emit galvanic or ionising currents.

Therefore, it is essential to have a bracelet, plate or similar component (8) which is placed in direct contact with the patient's skin, closing the electric circuit.

A vibrator (3) is positioned on the transducer, which effects a massaging motion on the skin.

Optionally, a minimum of one roller (9) may be positioned on each side of the transducer.

By means of the indicators (5) on the handle (4), the operator can see at any time what type of treatment is being applied to his/her patient. And, by using the switch (6), he/she can control the movement of the motorised rollers (9).

An ultrasound generator (not illustrated) produces ultrasound impulses, as well as galvanic currents, and the whole system is controlled by a central control panel.

Having explained the concepts behind the invention, the note of claims is drafted next, thus establishing the inventions which are the subject of the claims.

1.- “ULTRASOUND ENDOMASSAGE DEVICE”, used in massage, slimming and anti-cellulitis treatments, characterised essentially by being comprised of a casing (1) which houses in its interior an ultrasound transducer (2) on whose body are a series of passing holes (7) through which suction, produced by a vacuum pump, is exerted; the casing has a handle (4) on which indicators and an operating switch can be found.

2.- “ULTRASOUND ENDOMASSAGE DEVICE”, as described in the claim above, characterised by the outer face of the transducer (2), which comes into contact with the skin, being concave.

3.- “ULTRASOUND ENDOMASSAGE DEVICE”, as described in the first and second claims, characterised by the outer face of the transducer (2), which comes into contact with the skin, being convex.

4.- “ULTRASOUND ENDOMASSAGE DEVICE”, as described in the first and second claims, characterised by the outer face of the transducer (2), which comes into contact with the skin, being flat.

5.- “ULTRASOUND ENDOMASSAGE DEVICE”, as described in the claims above, characterised by the body of the transducer (2) being used as a cathode for emitting galvanic or ionising currents.

6.- “ULTRASOUND ENDOMASSAGE DEVICE”, as described in the claims above, characterised by the ultrasound transducer (2), which also applies galvanic currents, having a bracelet, plate or similar component (8) which is placed in direct contact with the patient's skin as a sort of anode.

7.- “ULTRASOUND ENDOMASSAGE DEVICE”, as described in the claims above, characterised by the presence of a vibrating motor (3) joined to the transducer (2).

8.- “ULTRASOUND ENDOMASSAGE DEVICE”, as described in the claims above, characterised by the presence, optionally, of rollers (9) on each side of the transducer (2):

9.- “ULTRASOUND ENDOMASSAGE DEVICE”, as described in the claims above, characterised by the rollers (9) being motorised.

10.- “ULTRASOUND ENDOMASSAGE DEVICE”, as described in the claims above, characterised by the galvanic current generator, ultrasound generator and suction pump being arranged in a separate casing joined to the casing with the handle by a hose provided with a suction tube and a number of electrical cables, for operating the transducer, vibrating motor and other electrical devices.

11.- “ULTRASOUND ENDOMASSAGE DEVICE”, as described in claims 1 to 10, characterised essentially by the inclusion of the galvanic current generator, ultrasound generator and suction pump in the interior of the casing with the handle.
